(19) United States
(12) Patent Application Publication
(10) Pub. No.: US 2009/0107025 A1
(43) Pub. Date: Apr. 30, 2009

(54) WILDLIFE DECOY

(76) Inventor: Richard Bolton, Waldorf, MD (US)

Correspondence Address: John Alumit, 16830 Ventura Blvd. Suite 360, Encino, CA, 91436, US

(21) Appl. No.: 12/261,947

(22) Filed: Oct. 30, 2008

Related U.S. Application Data
(60) Provisional application No. 60/984,047, filed on Oct. 31, 2007.

(51) Int. Cl. A01M 31/06

(52) U.S. Cl. 43/2

(57) ABSTRACT

A device for attracting animals by simulating food on the ground or water is disclosed. The device comprises at least one simulated corn kernel that is arranged to look like a pile of corn kernels and an attachment means fixed on at least one end of said simulated corn kernel. A pile of simulated corn kernels linked together by an attachment means to form a continuous strand of any desired length. The attachment means are selected from a group consisting of hooks and eyes, loops, push and pull type links or any other means of suitable connection. In one embodiment, a hole of said simulated corn kernel is adapted to receive the attachment means thereby forming a continuous row of simulated corn kernels of any desired length. In another embodiment, a string connects the simulated corn kernel to form a strand of simulated corn kernels.

### CROSS-REFERENCE TO RELATED APPLICATION

This application claims the benefit of the priority date of provisional application No. 60/984,047 filed on Oct. 31, 2007.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to decoys, and more particularly to a device for attracting animals by simulating food on the ground or water.

From ancient history, decoys made of rushes, reeds and small twigs are used to attract waterfowl. These decoys attract the desired animal to the vicinity of the hunter's blind. As the waterfowl decoys simulate the appearance of various waterfowl creatures, the decoy mechanisms are used by hunters to get the waterfowl within shooting range.

Several decoy devices for attracting animals have been developed in the art. U.S. Pat. No. 4,318,240 to Hillesland discloses decoys for hunting waterfowl. The decoy is provided as a plurality of stackable flat sheets, each suitably decorated on each opposite surface thereof to resemble a different species of fowl and having integral tabs and interfitting slits. Each sheet can be readily converted from a flat configuration to a three-dimensional decoy. The decoy is deployed by anchoring the decoy into the ground with the help of a removable stake that extends through openings in a pair of tabs.

In U.S. Pat. No. 4,607,447 to Wright, a food decoy mat to attract waterfowl is disclosed. The apparatus comprises an enlarged flexible member having transparent portions and opaque portions. The opaque portions represent scattered individual kernels and/or piles of grain. Additionally, the apparatus is adapted to be operatively connected to a waterfowl decoy in its deployed position.

U.S. Pat. No. 4,890,408 to Heiges discloses a waterfowl decoy for use in the hunting of waterfowl such as ducks and geese. The device is comprised of a solid molded body having a layer of burlap-like material adhesively secured to the outer surface of the solid molded body. A fabric covering is coated with the adhesive. A shaped head is affixed to the body, and the coated fabric layer is painted to resemble a selected waterfowl species. A keel including means for securing and retaining an anchor line is provided on the bottom of the body. The keel includes a recess particularly adapted for retaining a deployed anchor line.

U.S. Pat. No. 6,170,188 to Mathews discloses an apparatus for attracting waterfowl. The waterfowl decoy apparatus includes a decoy housing, a pair of decoy wing members rotatably connected to the decoy housing and an elongated stand supporting the housing to position the decoy housing over the surface of a body of water. The apparatus may be readily converted between wind powered operation and motor powered operation.

Most of the above decoys mimic waterfowl at rest. This demonstration is quite unnatural and can cause the waterfowl to fly away from a pond or meadow. Some of the above devices require the hunter to disassemble the decoys for stacking. In addition, in such a device the hunter needs to separately store the anchors. Some other devices do not provide any means for the decoy to pivot into the wind, as is evidenced by the attachment of the decoy to a series of square section tubes that cannot rotate relative to one another. Further, such motorized decoy mechanisms are not universally legal for hunting. When employed, the motor is susceptible to power and mechanical failure. These and similar decoy arrangements can often be cumbrous to carry to the hunting/viewing site because of the size and weight of the decoys themselves in addition to whatever supporting equipment they require. Moreover, these decoys are time-consuming to construct on-site due to the relative complexity of their assembly. For the same reasons, it can be difficult to modify the configurations of these arrangements to adjust to weather and other on-site conditions.

It is therefore, an object of the present invention is to provide a decoy device for attracting animals thinking the device placed on the ground or in the water, to be food. Another object of the invention is to provide a device with continuous links that can be fed off of a roll. Other objects of the present invention will become better understood with reference to the appended Summary, Description and Claims.

### SUMMARY

The present invention is a device for attracting animals by simulating food on the ground or water. The device comprises at least one simulated corn kernel arranged to look like a pile of corn kernels and an attachment means fixed on at least one end of said simulated corn kernel. A pile of simulated corn kernels linked together by the attachment means to form a continuous strand of any desired length. The attachment means are selected from a group consisting of hook and eyes, loops, push and pull type links or any other means of suitable connection.

In one embodiment, a hole at one end of a simulated corn kernel is adapted to receive an attachment means at the other end thereof. Thus, a continuous row of simulated corn kernels of any desired length could be formed.

In another embodiment, a string connects the simulated corn kernel to form a strand of simulated corn kernels that can be easily cut with ordinary scissors to any desired length. The individual simulated corn kernel has the same size of a real corn kernel. The strand of simulated corn kernels can be wound onto a spool for easy dispensing and storage.

The device is made of a yellow plastic material that is capable of floating in water. The device may be made of a biodegradable material that is eco-friendly. The device can be packaged in a bag or other packaging material for sale to consumers.

### BRIEF DESCRIPTION OF THE FIGURES

FIG. 1 is a perspective view of the invention, illustrating at least one simulated corn kernel arranged to look like a pile of corn kernels.

FIG. 2A is a perspective view of the invention, illustrating a pile of simulated corn kernels linked together by attachment means to form a continuous strand of any desired length.

FIG. 2B is a perspective view of an alternate embodiment of FIG. 2A, illustrating a pile of simulated corn kernels linked together by using push and pull type link.

FIG. 3 is a perspective view of an alternate embodiment of the invention, illustrating a row of simulated corn kernels connected by an attachment means.

FIG. 4 is a perspective view of another alternate embodiment of the invention, illustrating a strand of simulated corn kernels.

FIG. 5 is a perspective view of different embodiments of the invention packaged.

FIG. 6 is a perspective view of the embodiment of FIG. 4, illustrating a spool wound with a strand of simulated corn kernels.

FIG. 7 is a perspective view of all the embodiments in use.

### REFERENCE NUMERALS

10 Device of the Present Invention
12 At least one simulated corn kernel
12a Pile of simulated corn kernels
12b Row of simulated corn kernels
12c Strand of simulated corn kernels
14 Attachment means
16 String
18 Bag
20 Spool
22 Animals
24 Water

### DETAILED DESCRIPTION

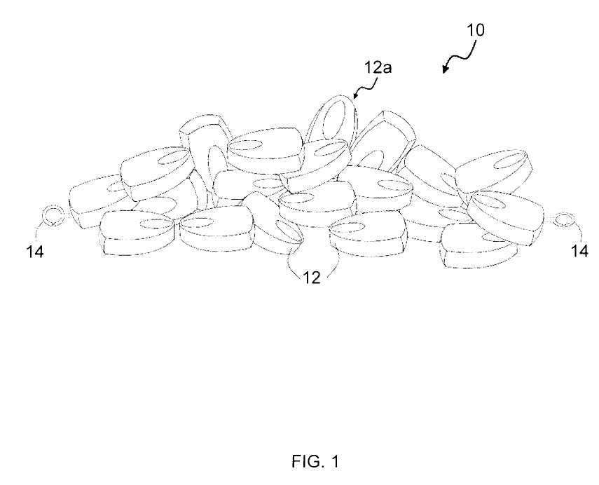

Referring to the drawings, a preferred embodiment of a device for attracting animals 22 by simulating food on the ground or water 24 is illustrated and generally indicated as 10 in FIGS. 1 through 7. The device 10 comprises at least one simulated corn kernel 12 arranged to look like a pile of corn kernels and an attachment means 14 fixed on at least one end of said simulated corn kernel 12.

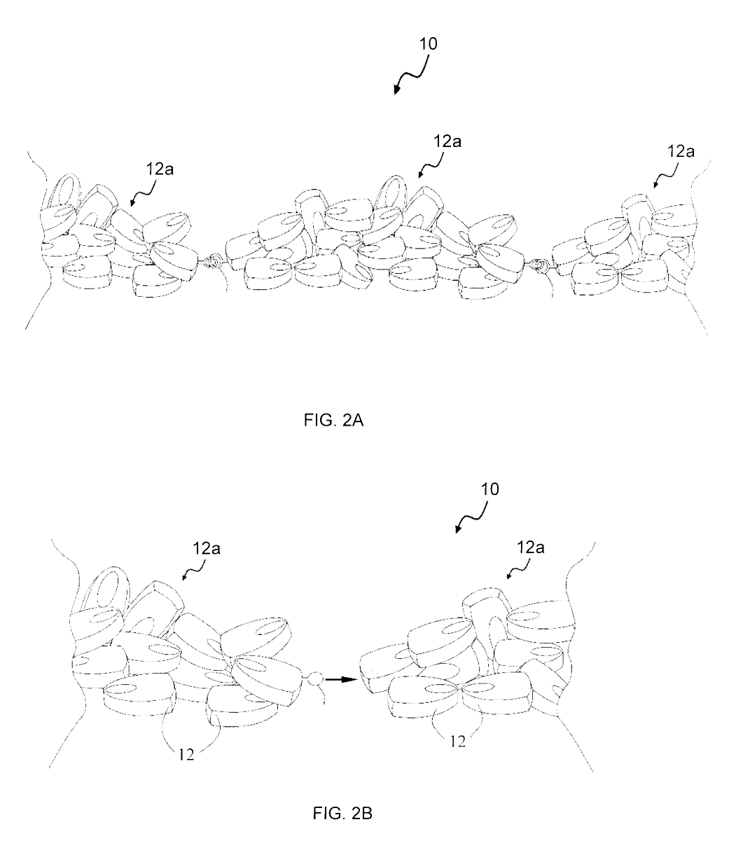

FIG. 2A illustrates a pile of simulated corn kernels 12a linked together by an attachment means 14 to form a continuous strand of any desired length that is adapted to attract the animals 22. The attachment means 14 are selected from a group consisting of hook and eyes, loops, push and pull type links or any other means of suitable connection. The overall length of the device 10 can be increased by linking more numbers of a pile of simulated corn kernels 12a with the attachment means 14.

The device 10 is made of a yellow plastic material that is capable of floating in water 24. The device 10 may be made of a biodegradable material that is eco-friendly. The individual simulated corn kernel 12 has the same size of a real corn kernel.

FIG. 2B illustrates an alternate embodiment of FIG. 2A which provides a pile of simulated corn kernels 12a linked together by using a push and pull type link.

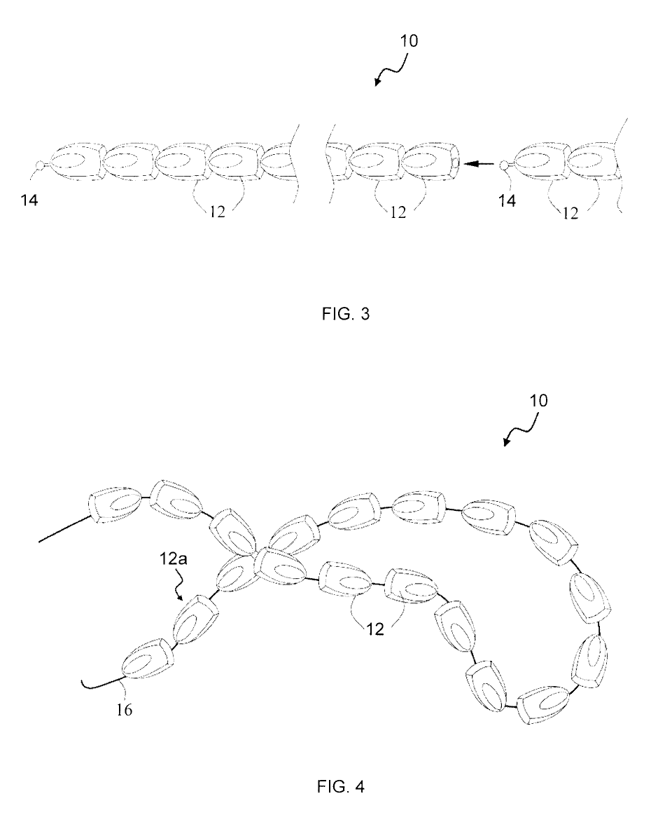

FIG. 3 is an illustration of an alternate embodiment of the invention in which a row of simulated corn kernels 12b is connected by an attachment means 14. The simulated corn kernel 12 has two ends wherein one end has a hole and another end has the attachment means 14. The hole is adapted to receive the attachment means 14 thereby forming a continuous row of simulated corn kernels 12b of any desired length.

FIG. 4 illustrates another alternate embodiment of the invention in which a simulated corn kernel 12 is connected by a string 16 to form a strand of simulated corn kernels 12c. The strand of simulated corn kernels 12c can be easily cut with ordinary scissors to any desired length.

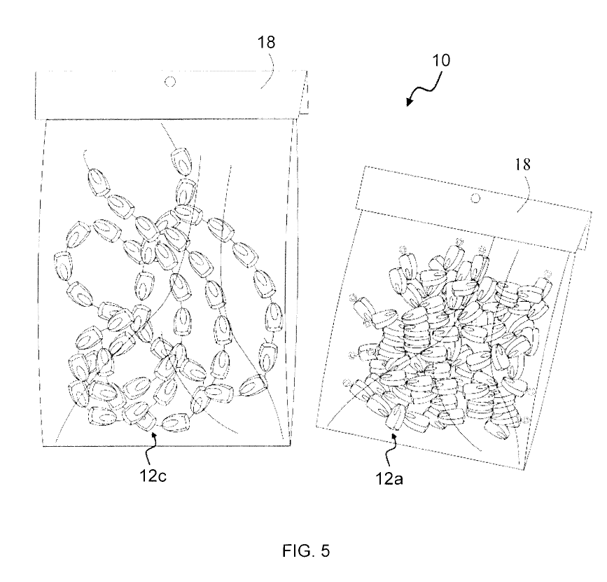

FIG. 5 illustrates different embodiments 12a, 12b and 12c of the invention packaged. The device 10 can be packaged in a bag 18 or other packaging material for sale to consumers.

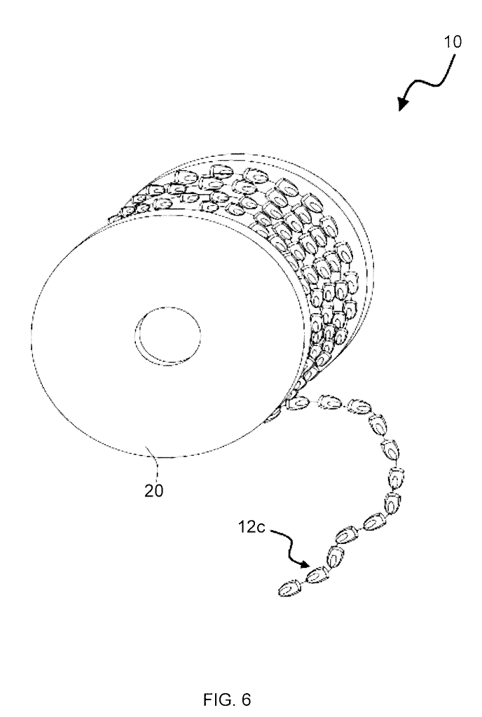

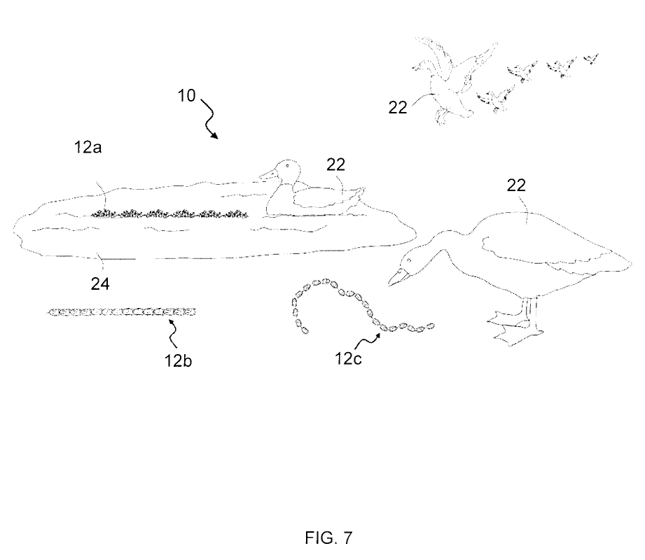

FIG. 6 illustrates the embodiment of FIG. 4 in which a spool 20 is wound with a strand of simulated corn kernels 12c. The spool or a roll 20 allows comfortable dispensing and storage of the strand of simulated corn kernels 12c. Referring to FIG. 7, all the embodiments 12a, 12b and 12c in use are illustrated.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

The invention claimed is:

1. A device for attracting animals by simulating food on the ground or water comprising:
a. at least one simulated corn kernel arranged to look like a pile of corn kernels; and
b. an attachment means fixed on at least one end of said simulated corn kernel;
c. whereby a pile of simulated corn kernels linked together by said attachment means to form a continuous strand of any desired length that is adapted to attract the animals.

2. The device of claim 1, wherein said attachment means are selected from a group consisting of hooks and eyes, loops, push and pull type links or any other means of suitable connection.

3. The device of claim 1, wherein the device is made of a yellow plastic material.

4. The device of claim 1, wherein the device may be made of a biodegradable material.

5. The device of claim 1, wherein said simulated corn kernel has the same size of a real corn kernel.
